(19) United States
(12) Patent Application Publication
(10) Pub. No.: US 2020/0387346 A1
(43) Pub. Date: Dec. 10, 2020

(54) ELECTRIC DEVICE

(71) Applicant: SHARP KABUSHIKI KAISHA, Sakai City (JP)

(72) Inventors: YOSHIHIKO HAMAGUCHI, Sakai City (JP); XINYUE ZHANG, Sakai City (JP)

(21) Appl. No.: 16/890,560

(22) Filed: Jun. 2, 2020

(30) Foreign Application Priority Data
Jun. 6, 2019 (JP) 2019-106308

(51) Int. Cl. G06F 3/16

(52) U.S. Cl. CPC G06F 3/165

(57) ABSTRACT

An electric device includes: a communications unit configured to communicate with an access point; a person detector configured to detect presence of a person; and a controller configured to enable a person detection response operation to be performed based on detection of the presence of the person by the person detector if the communications unit is connected to the access point.

### CROSS-REFERENCE TO RELATED APPLICATION

The present application claims priority from Japanese Application JP2019-106308, the content to which is hereby incorporated by reference into this application.

### BACKGROUND OF THE INVENTION

### 1. Field of the Invention

The present invention relates to an electric device including a person detector.

### 2. Description of the Related Art

Japanese Unexamined Patent Application Publication No. 2003-28550 discloses a conventional refrigerator known in the art which, for example, automatically sends an audio announcement when detecting presence of a person near the refrigerator.

### SUMMARY OF THE INVENTION

The refrigerator disclosed in Japanese Unexamined Patent Application Publication No. 2003-28550 has such a problem as sending an audio announcement when a user feels unnecessary to hear the announcement.

An aspect of the present invention is intended to provide an electric device capable of appropriately performing a person detection response operation when detecting a person.

In order to overcome the above problem, an electric device according to an aspect of the present invention includes: a communications unit communicating with an access point; a person detector detecting presence of a person; and a controller enabling a person detection response operation to be performed based on the presence of the person by the person detector if the communications unit is connected to the access point.

An aspect of the present invention makes it possible to appropriately perform a person detection response operation based on the presence of the person.

### BRIEF DESCRIPTION OF THE DRAWINGS

FIG. 1 illustrates a configuration of a refrigerator control system including a refrigerator according to an embodiment of the present invention;

FIG. 2 illustrates a block diagram showing a configuration of a control system of the refrigerator illustrated in FIG. 1;

FIG. 3 illustrates a block diagram showing a configuration of a control system of a server illustrated in FIG. 1;

FIG. 4 illustrates a perspective view of the refrigerator according to an embodiment of the present invention;

FIG. 5 illustrates an elevation view and a side view showing a detection area covered by a motion sensor included in the refrigerator illustrated in FIG. 4;

FIG. 6 illustrates a flowchart showing a basic operation of the refrigerator illustrated in FIG. 1;

FIG. 7 illustrates a flowchart showing an operation of the refrigerator illustrated in FIG. 1, the operation being performed when an external message is found;

FIG. 8 illustrates a flowchart showing an operation of a refrigerator according to another embodiment of the present invention, the operation being performed when a user message is found;

FIG. 9 illustrates a flowchart showing an operation of a refrigerator according to still another embodiment of the present invention, the operation including a case where no message from a cloud server is found;

FIG. 10 illustrates a block diagram showing a configuration of a control system of a refrigerator according to still another embodiment of the present invention; and

FIG. 11 illustrates a block diagram showing a configuration of a control system of a refrigerator according to still another embodiment of the present invention.

### DETAILED DESCRIPTION OF THE INVENTION

Described in the embodiments below is a case where an electric device is, for example, a refrigerator. Note that, other than the refrigerator, the electric device may also be, for example, an air conditioner, a cooker, a washing machine, a vacuum cleaner, or a lamp.

### First Embodiment

Described below in detail is an embodiment of the present invention.

Configuration of Refrigerator Control System 1

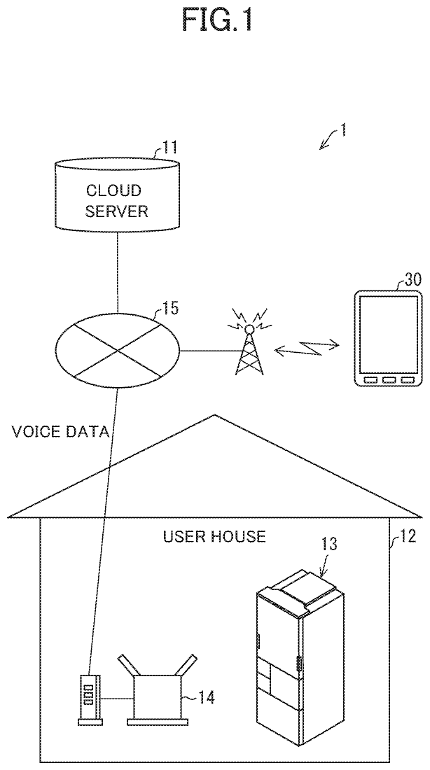

FIG. 1 illustrates a configuration of a refrigerator control system 1 including a refrigerator 13 according to this embodiment. In the refrigerator control system 1 illustrated in FIG. 1, the refrigerator 13 installed in a user house 12 and a cloud server (an external apparatus) 11 are connected together through a communications network 15. The connection between the refrigerator 13 and the cloud server 11 is set when, for example, the refrigerator 13 is installed in the user house 12. The setting in this case involves establishing continuous connection between the refrigerator 13 and the cloud server 11 basically while the refrigerator 13 is in operation. Note that, depending on a wish of the user, the setting may: leave the refrigerator 13 and the cloud server 11 disconnected; or allow the user to selectively connect the refrigerator 13 to the cloud server 11 or disconnect the refrigerator from the cloud server 11.

The refrigerator 13 is an electric appliance included in a network and having a wireless communications function for connecting to the communications network 15 and communicating with the cloud server 11. The wireless communications function may be provided inside the body of the refrigerator 13 or provided to a communications adaptor externally mounted on the body of the refrigerator 13.

The user house 12 is provided with a wireless local area network (LAN) to connect the refrigerator 13 to the communications network 15. The wireless LAN has a wireless access point 14 connected to the communications network 15 including the Internet. Examples of the wireless access point 14 include communications devices such as a WiFi (Registered) router and a WiFi (Registered) access point. In this embodiment, the communications network 15 includes, for example, the Internet. Alternatively, the communications network 15 may also include a telephone network, a mobile communications network, a cable television (CATV) communications network; and a satellite communications network.

Moreover, a communications terminal 30 held by the user can be connected to the communications network 15. The communications terminal 30 is, for example, a smartphone.

The refrigerator 13 is capable of voice interaction which involves obtaining voice that the user delivers in a speech and delivering a reply in response to the obtained voice. In this case, the refrigerator 13 transmits, to the cloud server 11, voice data of the obtained voice. The cloud server 11 performs voice recognition on the voice data received from the refrigerator 13 to identify a content of the speech. Then, the cloud server 11 transmits, to the refrigerator 13, reply voice data (a reply message) based on the identified content. The reply voice data is voice data to be delivered from the refrigerator 13. Examples of the reply voice data include voice data in response to an inquiry from the user, and voice data presenting an appropriate response to the content of the speech of the user.

Note that the refrigerator 13 may be capable of the speech recognition. That is, the refrigerator 13 may perform the speech recognition to identify a content of the speech, transmit the identified content to the cloud server 11, and receive the reply voice data from the cloud server 11.

Configuration of Refrigerator 13

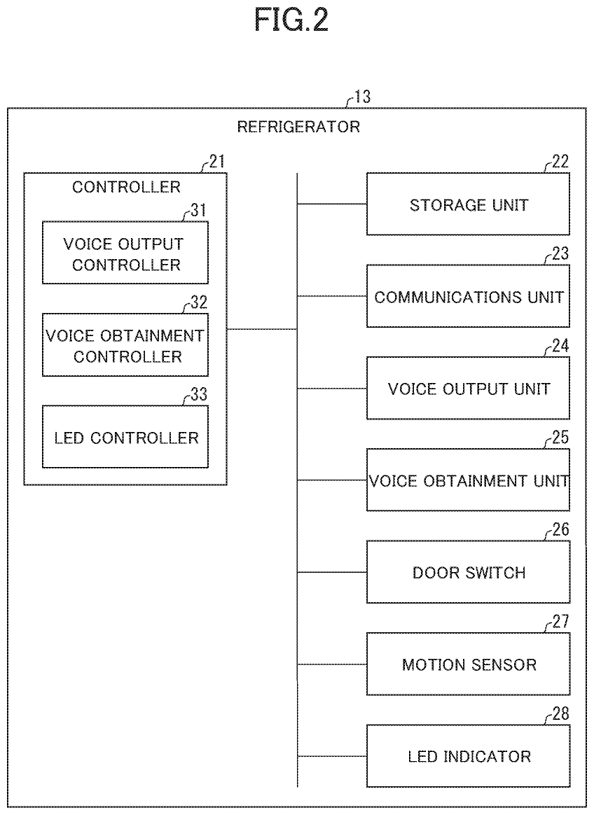

FIG. 2 illustrates a block diagram showing a configuration of a control system of the refrigerator 13. As illustrated in FIG. 2, the refrigerator 13 includes: a controller (a message obtainer) 21; a storage unit 22; a communications unit 23; a voice output unit 24; a voice obtainment unit 25; a door switch (a stopper, a door-close sensor, a door-open sensor, and a person detector) 26; a motion sensor (a person detector) 27; and an LED indicator (an indicator) 28. The controller 21 includes: a voice output controller 31; a voice obtainment controller 32; and an LED controller (an indicator controller) 33. The voice output unit (an announcement unit) 24, the voice obtainment unit 25; the LED indicator (an announcement unit) 28, the voice output controller 31, the voice obtainment controller 32, and the LED controller 33 correspond to a person detection response operation unit. The operation performed by the person detection response operation unit corresponds to a person detection response operation.

The controller 21 includes, for example, a microcomputer including an arithmetic processor such as a central processing unit (CPU) and a dedicated processor. The controller 21 controls operations of the units included in the refrigerator 13.

The storage unit 22 stores various kinds of information to be used for the refrigerator 13. The storage unit 22 also stores the voice data downloaded from the cloud server 11 to be delivered, and the reply voice data in the voice interaction. The communications unit 23 is controlled by the controller 21 to mutually communicate with the cloud server 11 through the wireless AP 14 and the communications network 15. The access point shall not be limited to a wireless access point (the wireless AP 14), but may be a wired access point. In this case, the communications unit 23 is connected to the wired access point through a cable.

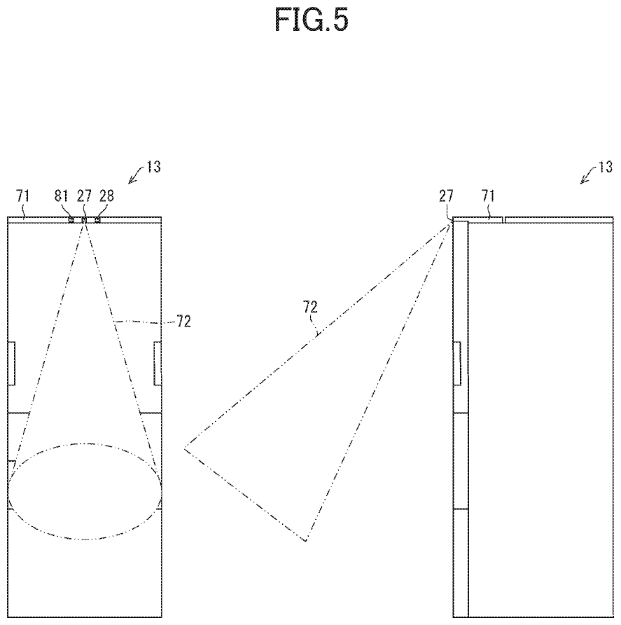

The voice output unit 24 includes a speaker. Through control of the voice output controller 31, the voice output unit 24 outputs voice based on voice data. The voice obtainment unit 25 includes a microphone (an audio input unit in FIG. 5) 81. Through control of the voice obtainment controller 32, the voice obtainment unit 25 obtains voice, and converts the obtained voice into an electric signal.

The door switch 26 detects whether a door (e.g., a first door 61) of the refrigerator 13 is open or closed. The motion sensor 27 detects presence of a person in front of the refrigerator 13. The motion sensor 27 may be such a known sensor as: an infrared sensor and a pyroelectric sensor capable of detecting temperature variation; and a distance sensor capable of detecting presence of an object. The LED indicator 28 presents different glowing states to display various states of the refrigerator 13.

The voice output controller 31 controls the voice output unit 24. Specifically, when voice data to be delivered is found, the voice output controller 31 causes the voice output unit 24 to deliver the voice data. The voice data to be delivered includes voice data received from the cloud server 11 and voice data stored in the storage unit 22.

The voice obtainment controller 32 controls the voice obtainment unit 25 and processing on the voice obtained by the voice obtainment unit 25. Specifically, the voice obtainment controller 32 controls ON and OFF of the microphone 81 included in the voice obtainment unit 25. Moreover, the voice obtainment controller 32 causes the communications unit 23 to transmit to the cloud server 11 voice data obtained by the microphone 81. Furthermore, when obtaining voice data from the cloud server 11, the voice obtainment controller 32 causes the storage unit 22 to store the voice data.

The LED controller 33 controls an operation of the LED indicator 28 so that the LED indicator 28 glows depending on various states of the refrigerator 13. Specifically, the LED controller 33 controls the LED indicator 28 so that, depending on the various states, the LED indicator 28 presents glowing states as follows: white when the microphone is ON; pink when an external message is found; blue when a user message is found; and green when the refrigerator is in response.

Note that the external message is a message related to various kinds of information to be transmitted from the cloud server 11 and another cloud server. Moreover, the user message is a message transmitted from the user of the refrigerator 13 to another user. The user message is obtained by the microphone 81 of the voice obtainment unit 25.

Note that the controller 21 may cause the motion sensor 27 to detect a person only when the refrigerator 13 is connected to the cloud server 11.

Configuration of Cloud Server 11

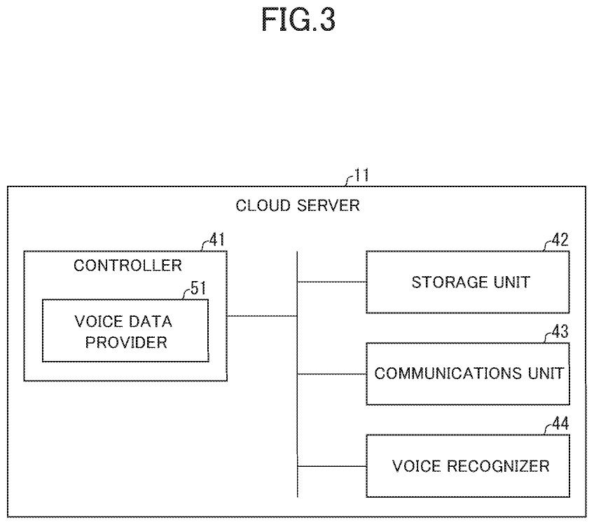

FIG. 3 illustrates a block diagram showing a configuration of a control system of the cloud server 11. As illustrated in FIG. 3, the cloud server 11 includes: a controller 41; a storage unit 42; a communications unit 43; and a voice recognizer 44. The controller 41 includes a voice data provider 51.

The controller 21 includes, for example, a microcomputer including an arithmetic processor such as a CPU and a dedicated processor. The controller 21 controls operations of the units included in the cloud server 11.

The storage unit 42 stores various kinds of information to be used for the cloud server 11, as well as various sample sentences to which the voice data provider 51 refers when the voice data provider 51 creates voice data to be provided to the refrigerator 13. The communications unit 43 is controlled by the controller 41 to communicate with the refrigerator 13 or another cloud server through the communications network 15.

The controller 41 causes the storage unit 42 to store the user message transmitted from the refrigerator 13 or the communications terminal 30. Furthermore, in response to a request from the refrigerator 13, the controller 41 causes the communications unit 43 to transmit, to the refrigerator 13, the user message stored in the storage unit 42.

Moreover, in response to a request from the refrigerator 13, the controller 41 causes the communications unit 43 to transmit, to the refrigerator 13, an information message which the controller 41 itself obtains or an information message which another cloud server obtains. The information messages are information to be provided to the refrigerator 13, and are mainly beneficial for the user of the refrigerator 13.

The voice recognizer 44 performs voice recognition on the voice data transmitted from the refrigerator 13 and received by the communications unit 43, and converts the voice data into a text string. The voice recognizer 44 is capable of converting voice data not only into a mere text string, but also into a sentence to make sense.

The audio data provider 51 provides the refrigerator 13 with reply voice data in response to the voice data on which the voice recognition is performed. In this case, the voice data provider 51 creates the reply voice data with reference to information stored in the storage unit 42, and obtains the reply voice data through the communications network 15.

Configuration of Refrigerator 13

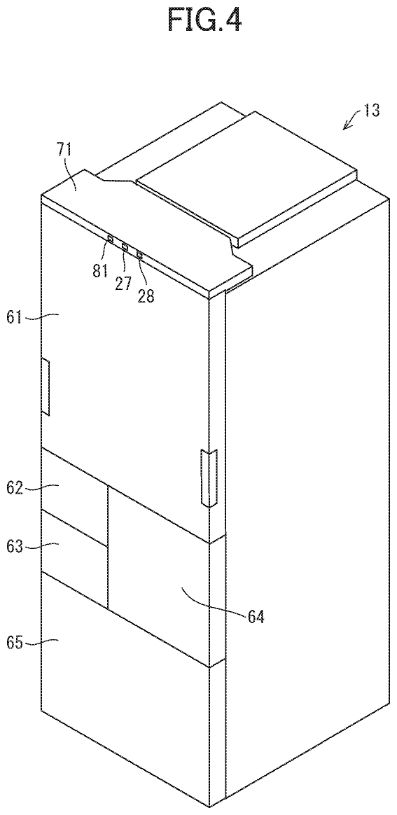

FIG. 4 illustrates a perspective view of the refrigerator 13. FIG. 5 illustrates an elevation view and a side view showing a detection area covered by a motion sensor included in the refrigerator 13.

As illustrated in FIG. 4, the refrigerator 13 includes, for example, the first door 61 to a fifth door 65 from top to bottom. The first door 61 is provided to a refrigerator compartment (a housing chamber). The second door 62 is provided to an ice dispenser (a housing chamber). The third door 63 is provided to a first freezer compartment (a housing chamber). The fourth door 64 is provided to a vegetable compartment (a housing chamber). The fifth door 65 is provided to a second freezer compartment (a housing chamber). The first door 61 is a single door capable of opening either from the left or the right.

The refrigerator 13 has a top face provided with an additional unit 71. The additional unit 71 includes: the motion sensor 27; the LED indicator 28; the microphone 81 included in the voice obtainment unit 25; and, for example, the door switch 26 (see FIG. 2) to detect whether the first door 61 is open or closed. As illustrated in FIG. 4, the motion sensor 27, the LED indicator 28, and the microphone 81 are arranged on a front face of the additional unit 71. The motion sensor 27 covers a detection area 72 illustrated in FIG. 5 to detect presence of a person (the user) in front of, and near, the refrigerator 13.

Basic Operation of Refrigerator 13

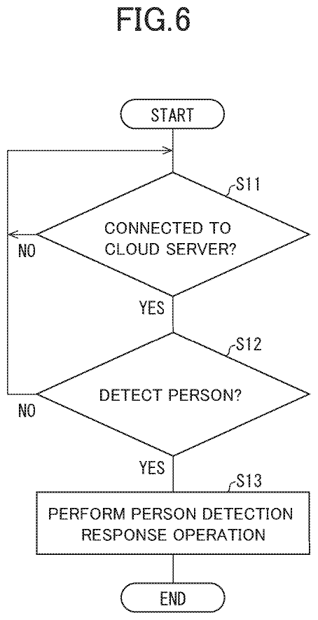

Described below is a basic operation of the refrigerator 13 in the refrigerator control system 1 of the above configuration. FIG. 6 illustrates a flowchart showing a basic operation of the refrigerator 13.

As illustrated in FIG. 6, when the refrigerator 13 is activated, the controller 21 of the refrigerator 13 determines whether the communications unit 23 is in a connection state capable of communicating with the cloud server 11; that is, whether the communications unit 23 is connected to the wireless AP 14 (S11). If a result of the determination in S11 is YES and the motion sensor 27 detects a person (S12: YES), the controller 21 performs a person detection response operation (S13). Note that, in S12, the controller 21 may activate the motion sensor 27 when the result of the determination in S11 is YES, and determine whether the motion sensor 27 detects the person.

As can be seen, if the communications unit 23 is connected to the wireless AP 14, the controller 21 enables the person detection response operation to be performed based on detection of the presence of the person by the person detector (the motion sensor 27). Meanwhile, if the communications unit 23 is not connected to the wireless AP 14, the controller 21 disables the person detection response operation to be performed based on the detection by the person detector (the motion sensor 27). The same goes for other embodiments described below.

Here, the person detection response operation involves transmission and reception of information between the refrigerator 13 and the cloud server 11 when the person is detected. The person detection response operation includes, for example, an operation to provide the person with any information obtained from the cloud server 11, and an operation to obtain voice data of the person and to transmit the obtained voice data to the cloud server 11 so that the cloud server 11 processes the voice data. An example of the person detection response operation involves delivering, on a speech delivery function of the refrigerator 13, the information received from the cloud server 11 (i.e., an external message and a user message to be described later). Specifically, the operation to deliver on the speech delivery function is that (i) the voice obtainment controller 32 causes the storage unit 22 to store information received from the cloud server 11, and (ii) the voice output controller 31 causes the voice output unit 24 to reproduce the information stored in the storage unit 22.

Another example of the person detection response operation involves: turning ON the microphone 81 of the voice obtainment unit 25; obtaining voice data of the user by the microphone 81; transmitting the obtained voice data to the cloud server 11; receiving from the cloud server 11 reply voice data in response to the transmitted voice data; and delivering the reply voice data on the speech delivery function. The refrigerator 13 may perform all of the person detection response operations or any one of the person detection response operations.

Operation of Refrigerator 13 when External Message is Found

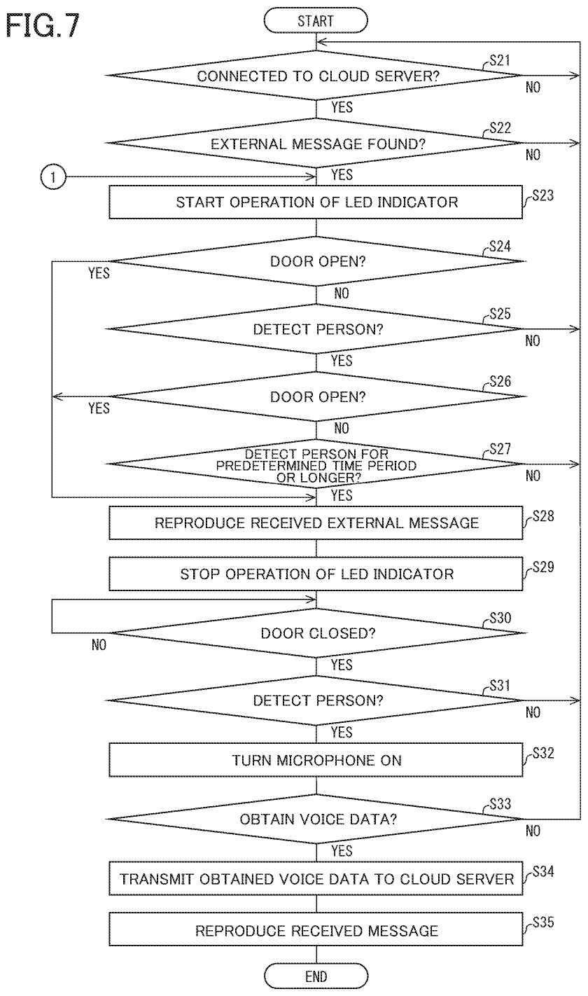

Described next is an operation of the refrigerator 13 in the refrigerator control system 1 when an external message is found. FIG. 7 illustrates a flowchart showing an operation of the refrigerator 13 when an external message is found. Note that, for example, the door to be opened and closed is, but not limited to, the first door 61.

As illustrated in FIG. 7, when the refrigerator 13 is activated, the controller 21 of the refrigerator 13 determines whether the communications unit 23 is in a connection state capable of communicating with the cloud server 11; that is, whether the communications unit 23 is connected to the wireless AP 14 (S21). If a result of the determination in S21 is YES, the controller 21 determines whether an external message is found in the cloud server 11 (S22). If the result of the determination in S22 is YES, the controller 21 causes the LED indicator 28 to start to glow (S23). Here, the LED indicator 28 glows pink

Next, if the door switch 26 detects that the first door 61 is closed (S24), the motion sensor 27 detects a person (S25), the first door 61 is not open (S26), and the motion sensor 27 detects the person for a predetermined time period or longer (S27), the controller 21 receives the external message from the cloud server 11 and reproduces the external message (S28). Then, the controller 21 causes the LED indicator 28 to stop glowing (S29).

Moreover, if the first door 61 is open in S24, the controller 21 proceeds to S28, and performs subsequent operations.

Note that when the refrigerator 13 reproduces the external message, the controller 21 causes the storage unit 22 to store the external message received from the cloud server 11, and reproduces the external message stored in the storage unit 22. The same goes for the case where the refrigerator 13 reproduces another message (information) received from the cloud server 11.

Moreover, a timing for receiving the external message shall not be particularly limited to the above timing. Furthermore, in S27, the predetermined time period or longer is taken to detect the person by the motion sensor 27 in order to keep the refrigerator 13 from responding in a case where the person passes by in front of the refrigerator 13. Thanks to the above operation, the refrigerator 13 can keep the motion sensor 27 from false detection, and reduce the risk of a failure in the person detection response operation. Hence, the refrigerator 13 can perform the person detection response operation only for a person who needs to visit the refrigerator 13 and the cloud server 11.

Next, if the first door 61 is closed (S30), and the motion sensor 27 detects a person (S31), the controller 21 turns ON the microphone 81 of the voice obtainment unit 25 (S32). Here, the LED indicator 28 glows white by the control of the LED controller 33. Then, if the microphone 81 obtains voice data (S33), the controller 21 causes the communications unit 23 to transmit the obtained voice data to the cloud server 11 (S34).

When the cloud server 11 receives the voice data from the refrigerator 13, the voice recognizer 44 performs voice recognition to identify a content of the voice data (a content of the speech of the user). If the voice recognizer 44 identifies that the received voice data is an inquiry from the user, the controller 41 transmits reply voice data to the refrigerator 13 in response to the identified content. The reply voice data is voice data to be delivered from the refrigerator 13. Examples of the reply voice data include voice data in response to an inquiry from the user, and voice data presenting an appropriate response to the content of the speech of the user.

Note that, if the controller 41 determines that the received voice data is a message from a first user to a second user, the controller 41 causes the storage unit 42 to store the voice data as a user message.

Next, when receiving the reply voice data from the cloud server 11, the controller 21 of the refrigerator 13 causes the voice output unit 24 to output the reply voice data as a message from the cloud server 11 (S35).

Advantages of Refrigerator 13

The refrigerator 13 of this embodiment allows the voice output unit 24 to perform a person detection response operation; that is, to deliver the external message obtained from the cloud server 11 when (i) the communications unit 23; namely the refrigerator 13, is in a connection state capable of communicating with the cloud server 11 (i.e., when the communications unit 23 is connected to the wireless AP 14), and (ii) the motion sensor 27 detects a person. Such features make it possible to appropriately perform a person detection response operation when a person is detected. Moreover, the features reduce the risk that the refrigerator 13 cannot announce a message transmitted from the cloud server 11 or that the refrigerator 13 delivers a needless speech, making it possible to appropriately perform a person detection response operation to announce an external message to a user.

Moreover, the refrigerator 13 of this embodiment allows the microphone 81 to perform a person detection response operation; that is, to turn ON the microphone 81 so that the microphone 81 obtains voice data indicating a content of a speech of the user when (i) the communications unit 23; namely the refrigerator 13, is in a connection state capable of communicating with the cloud server 11 (i.e., when the communications unit 23 is connected to the wireless AP 14), and (ii) the motion sensor 27 detects a person. The voice data of the user is transmitted to the cloud server 11, so that the cloud server 11 performs voice recognition on the voice data. As a result of the voice recognition, the cloud server 11 transmits, to the refrigerator 13, reply voice data in response to the voice data of the user. Then, the refrigerator 13 delivers the received reply voice data. Hence, the refrigerator 13 does not unnecessarily obtain voice data of the user, allowing the microphone (the audio input unit) 81 to appropriately perform a person detection response operation.

Moreover, after an announcement of a message finishes in S28, the refrigerator 13 enables the input of the voice (the input of a speech of the user) from the microphone 81 in S32. Hence, when a message to be announced to the user is found, such a feature allows the message to be announced to the user in priority to the voice input of the user, making it possible to appropriately perform a person detection response operation.

Moreover, the refrigerator 13 causes the LED indicator 28 to glow in different colors in order to indicate different operation states (e.g., an ON state of the microphone 81) and different kinds of messages held in the cloud server 11. Such a feature allows the user to easily recognize, by the LED indicator 28, an operation state (e.g., an ON state of the microphone 81) of the refrigerator 13 and a kind of a message held in the cloud server 11.

In the refrigerator 13 of this embodiment, the first door 61 is supposed to be closed when the microphone 81 turns ON. That is, if the user would like to converse with the refrigerator 13, the first door 61 needs to be closed. Such a feature can reduce the risk that the first door 61 is left open during the conversation, contributing to save energy of the refrigerator 13.

Moreover, the refrigerator 13 reproduces an external message received from the cloud server 11 if the first door 61 (or any one of the first door 61 to the fifth door 65) is open. Such a feature makes it possible to appropriately perform a person detection response operation when a person is present in front of the refrigerator 13. Note that the message to be reproduced here shall not be limited to the one received from the cloud server 11. Alternatively, the message may be the one held in the refrigerator 13.

### Second Embodiment

Described below in detail is another embodiment of the present invention. Identical reference numerals are used to denote identical or substantially identical components between this embodiment and the first embodiment. Hence, detailed descriptions of thereof will not be elaborated upon.

Operation of Refrigerator 13 when User Message is Found

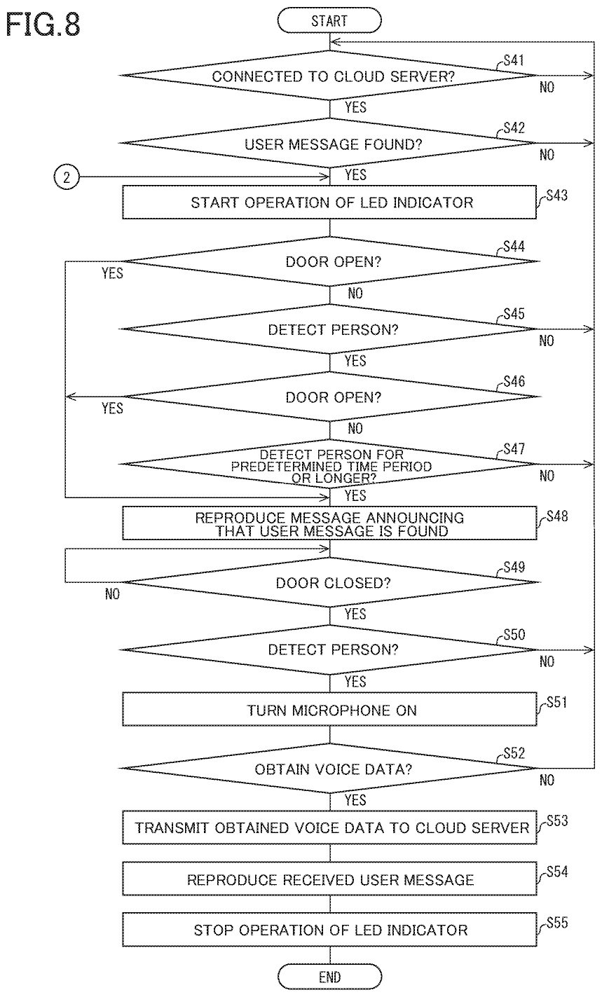

Described below is an operation of the refrigerator 13 in this embodiment when a user message is found. FIG. 8 illustrates a flowchart showing an operation of the refrigerator 13 when a user message is found.

On a premise of the operation in FIG. 8, the cloud server 11 holds a user message. As illustrated in FIG. 8, when the refrigerator 13 is activated, the controller 21 of the refrigerator 13 determines whether the communications unit 23 is in a connection state capable of communicating with the cloud server 11; that is, whether the communications unit 23 is connected to the wireless AP 14 (S41). If a result of the determination in S41 is YES, the controller 21 determines whether a user message is found in the cloud server 11 (S42). If the result of the determination in S42 is YES, the controller 21 causes the LED indicator 28 to start to glow (S43). Here, the LED indicator 28 glows blue.

Next, if the first door 61 is closed (S44), the motion sensor 27 detects a person (S45), the first door 61 is not open (S46), and the motion sensor 27 detects the person for a predetermined time period or longer (S47), the controller 21 causes the voice obtainment unit 25 to reproduce a message announcing that the user message is found (S48). This message goes, “You have two messages” when, for example, two user messages are found.

Moreover, if the first door 61 is open in S44, the controller 21 proceeds to S48, and performs subsequent operations.

Next, if the first door 61 is closed (S49), and the motion sensor 27 detects a person (S50), the controller 21 turns ON the microphone 81 of the voice obtainment unit 25 (S51). Here, the LED indicator 28 glows white by the control of the LED controller 33. Then, if the microphone 81 obtains voice data (S52), the controller 21 causes the communications unit 23 to transmit the obtained voice data to the cloud server 11 (S53). Note that the voice data to be obtained in S52 is, for example, “Reproducing the second message (Reproducing a message from Mr./Ms. . . . ).”

When the cloud server 11 receives the voice data from the refrigerator 13, the voice recognizer 44 performs voice recognition to identify a content of the voice data (a content of the speech of the user). If the content of the identified voice data is, “Reproducing the second message (Reproducing a message from Mr./Ms. . . . )”, the controller 41 transmits the second user message to the refrigerator 13. Note that if the controller 41 determines that the received voice data is a message from a first user to a second user, the controller 41 causes the storage unit 42 to store the voice data as the user message.

When receiving the user message from the cloud server 11, the controller 21 of the refrigerator 13 causes the voice output unit 24 to reproduce the user message (S54). Then, the controller 21 causes the LED indicator 28 to stop glowing (S55).

Advantages of Refrigerator 13

The refrigerator 13 of this embodiment allows the voice output unit 24 to perform a person detection response operation; that is, to deliver the user message obtained from the cloud server 11 when (i) the communications unit 23; namely the refrigerator 13, is in a connection state capable of communicating with the cloud server 11 (i.e., when the communications unit 23 is connected to the wireless AP 14), and (ii) the motion sensor 27 detects a person. Such features make it possible to appropriately perform a person detection response operation when a person is detected. Moreover, the features reduce the risk that the refrigerator 13 cannot announce a message from the cloud server 11 or that the refrigerator 13 delivers a needless speech, making it possible to appropriately perform a person detection response operation to announce a user message to a user.

Moreover, the refrigerator 13 reproduces a user message received from the cloud server 11 if the first door 61 (or any one of the first door 61 to the fifth door 65) is open. Such a feature makes it possible to appropriately perform a person detection response operation when a person is present in front of the refrigerator 13. Note that the message to be reproduced here shall not be limited to the one received from the cloud server 11. Alternatively, the message may be the one held in the refrigerator 13. Other advantages of the refrigerator 13 in this embodiment are the same as those of the refrigerator 13 in the first embodiment.

### Third Embodiment

Described below in detail is still another embodiment of the present invention. Identical reference numerals are used to denote identical or substantially identical components between this embodiment and the above embodiments. Hence, detailed descriptions of thereof will not be elaborated upon.

Operation of Refrigerator 13 Including Case where No Message from Cloud Server 11 is Found

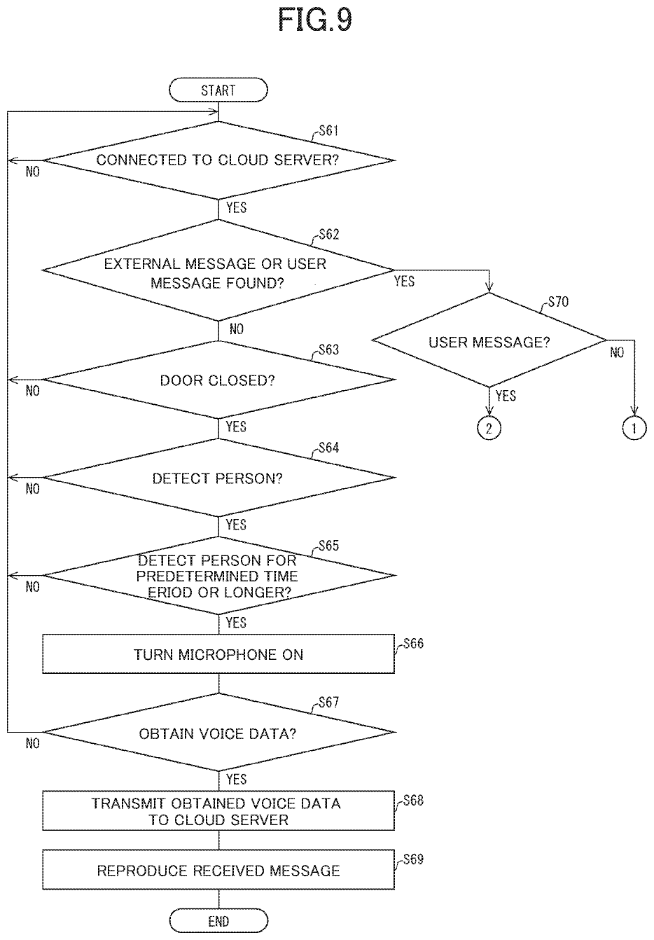

Described below is an operation of the refrigerator 13 according to this embodiment, the operation including a case where no message from the cloud server 11 is found. FIG. 9 illustrates a flowchart showing an operation of the refrigerator 13, the operation including a case where no message from the cloud server 11 is found.

As illustrated in FIG. 9, when the refrigerator 13 is activated, the controller 21 of the refrigerator 13 determines whether the communications unit 23 is in a connection state capable of communicating with the cloud server 11; that is, whether the communications unit 23 is connected to the wireless AP 14 (S61). If a result of the determination in S61 is YES, the controller 21 determines whether an external message or a user message is found in the cloud server 11 (S62).

If the result of the determination in S62 is NO, the first door 61 is closed (S63), the motion sensor 27 detects a person (S64), the first door 61 is not open (S65), and the motion sensor 27 detects the person for a predetermined time period or longer (S66), the controller 21 turns ON the microphone 81. Here, the LED indicator 28 glows white by the control of the LED controller 33.

Then, if the microphone 81 obtains voice data (S67), the controller 21 causes the communications unit 23 to transmit the obtained voice data to the cloud server 11 (S68).

When the cloud server 11 receives the voice data from the refrigerator 13, the voice recognizer 44 performs voice recognition to identify a content of the voice data (a content of the speech of the user). If the voice recognizer 44 identifies that the received voice data is an inquiry from the user, the controller 41 transmits, as described above, reply voice data to the refrigerator 13 in response to the identified content. Note that if the controller 41 determines that the received voice data is a message from a first user to a second user, the controller 41 causes the storage unit 42 to store the voice data as the user message.

Next, when receiving the reply voice data from the cloud server 11, the controller 21 of the refrigerator 13 causes the voice output unit 24 to output the reply voice data as a message from the cloud server 11 (S69).

Meanwhile, if an external message or a user message is found in the cloud server 11 as the result of determination in S62, the controller 21 determines whether the message is an external message or a user message (S70).

If the message is an external message as the result of the determination in S70, the controller 21 proceeds to an operation in S23 in FIG. 7, and performs subsequent operations. If the message is a user message, the controller 21 proceeds to an operation in S43 in FIG. 8, and performs subsequent operations. Note that if both of an external message and a user message are found as messages, these messages may be prioritized to be sequentially processed according to the priority.

Advantages of Refrigerator 13

As can be seen in the refrigerator 13 of the previous embodiments, the refrigerator 13 according to this embodiment may appropriately perform a person detection response operation which involves announcing an external message to a user, a person detection response operation which involves announcing a user message to a user, and a person detection response operation which involves obtaining voice data of a user and sending, in response to the voice data, a reply message in a speech. Other advantages of the refrigerator 13 in this embodiment are the same as those of the refrigerator 13 in the first embodiment.

### Fourth Embodiment

Described below in detail is still another embodiment of the present invention. Identical reference numerals are used to denote identical or substantially identical components between this embodiment and the above embodiments. Hence, detailed descriptions of thereof will not be elaborated upon.

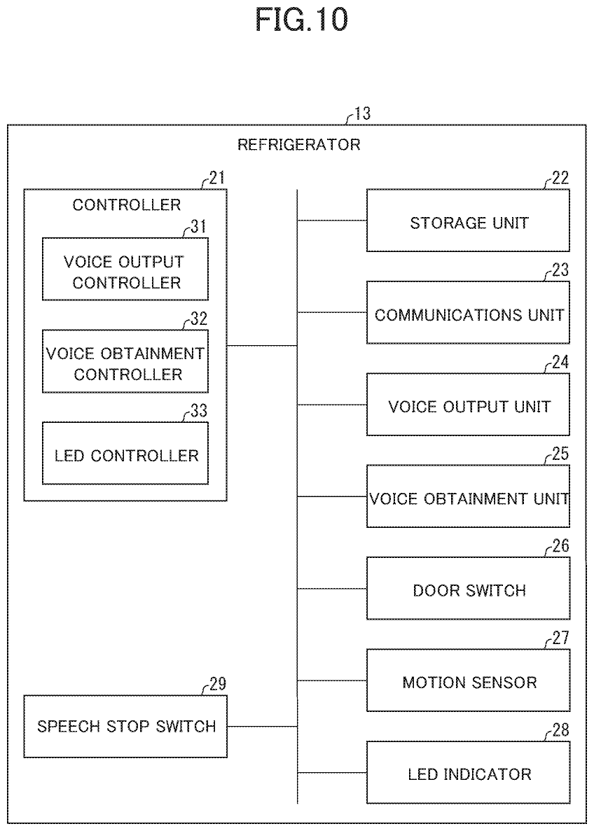

FIG. 10 illustrates a block diagram showing a configuration of a control system of the refrigerator 13 according to this embodiment. In the above embodiments, the refrigerator 13 may stop any one of or all of the person detection response operations. In this case, the refrigerator 13 may stop the speech delivery function if, for example, any one of the doors is open. Here, the speech is stopped by the door switch (a stopper) 26, and by the voice output controller 31 detecting, by the door switch 26, that the door is open. Alternatively, the refrigerator 13 may stop the speech delivery function if a speech stop switch (a stopper) 29, provided to the refrigerator 13, is pressed. In this case, the speech is stopped by the speech stop switch (a stopper) 29, and by the voice output controller 31 detecting the operation of the speech stop switch 29. Note that the speech stop switch 29 is any given switch provided to the refrigerator 13. For example, the speech stop switch 29 is provided to a refrigerator compartment having the first door 61.

The features of this embodiment make it possible to stop a person detection response operation of the refrigerator 13 when the user would not like the refrigerator 13 to perform a person detection response operation; that is, for example, when the user would not like the refrigerator 13 to deliver a speech in such a case as the user is on the phone or a guest is visiting the user.

Note that, other than the speech stop switch 29 and the door switch 26, the stopper may be separately provided from the refrigerator 13 and any switch of the refrigerator 13. The stopper may be a switch module mounted on the refrigerator 13, or a handheld terminal device such as a smartphone.

### Fifth Embodiment

Described below in detail is still another embodiment of the present invention. Identical reference numerals are used to denote identical or substantially identical components between this embodiment and the above embodiments. Hence, detailed descriptions of thereof will not be elaborated upon.

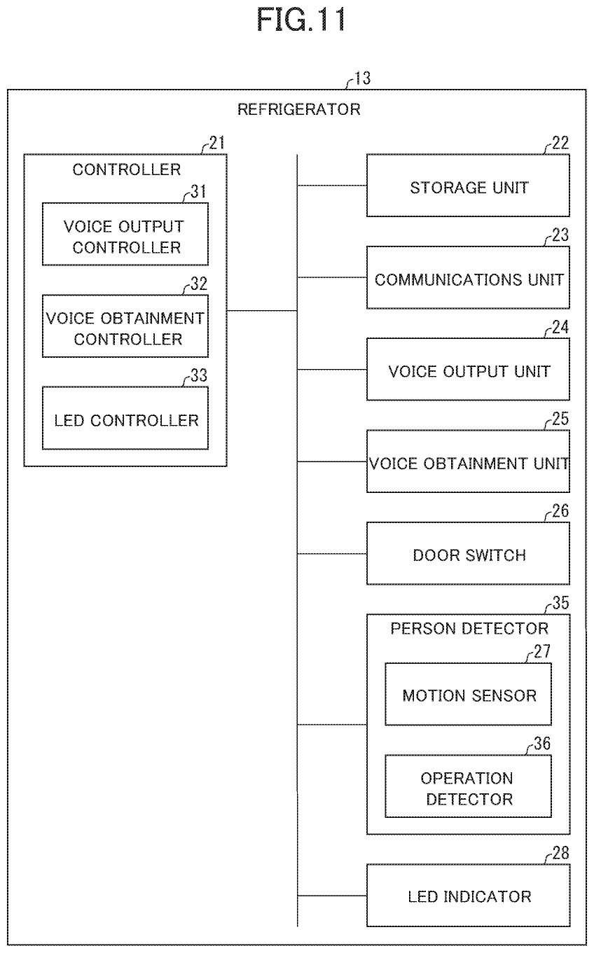

FIG. 11 illustrates a block diagram showing a configuration of a control system of the refrigerator 13 according to this embodiment. In the refrigerator 13 according to this embodiment, the person detector 35 including the motion sensor 27 further includes an operation detector 36. The operation detector 36 is, for example, an operation panel provided to the refrigerator 13. For example, the operation panel includes a liquid crystal display, and is controlled by a user. Note that, other than the operation panel, the operation detector 35 may be, for example, any given operation button and power button.

If the operation detector 36 detects an operation of the user on the operation detector 36 (e.g., an operation panel), the controller 21 controls the units so that the person detection response operations are performed. Such features make it possible for the refrigerator 13 to appropriately perform a person detection response operation when the operation detector 36 detects an operation of the user on the refrigerator 13; that is, when the person detector 35 detects a person. Other advantages of the refrigerator 13 in this embodiment are the same as those of the refrigerator 13 in the first embodiment.

Software Implementation

The control block (the controller 21) of the refrigerator 13 may be implemented by logic circuits (hardware) fabricated, for example, in the form of an integrated circuit (an IC chip) and may be implemented by software.

In the latter form of implementation, the refrigerator 13 includes a computer that executes instructions from programs or software by which various functions are implemented. This computer includes, for example, at least one processor (a control device), and at least one storage medium containing the programs in a computer-readable format. In the computer, the processor retrieves and runs the programs contained in the storage medium, thereby achieving the object of an aspect of the present invention. An example of the processor is a central processing unit (CPU). The storage medium may be a “non-transitory, tangible medium” such as a read-only memory (ROM), a tape, a disc/disk, a card, a semiconductor memory, or programmable logic circuitry. Moreover, the refrigerator 13 may further includes a random access memory (RAM) into which the programs are loaded. The programs may be supplied to the computer via any given transmission medium (e.g., over a communications network or by broadcasting waves) that can transmit the programs. The present invention, in an aspect thereof, encompasses data signals on a carrier wave that are generated during electronic transmission of the programs.

### SUMMARY

An electric device according to a first aspect of the present invention includes: a communications unit communicating with an access point; a person detector detecting presence of a person; and a controller enabling a person detection response operation to be performed based on the detection by the person detector if the communications unit is connected to the access point.

In the electric device according to a second aspect of the present invention, the person detector may include a motion sensor detecting the presence of the person, and the controller may perform the person detection response operation if the motion sensor detects the presence of the person for a predetermined time period or longer.

In the electric device according to a third aspect of the present invention, the person detector may include an operation detector detecting an operation of a user on the electric device, and the controller may perform the person detection response operation if the operation detector detects the operation of the user on the electric device.

The electric device according to a fourth aspect of the present invention may further include an information unit informing information wherein the person detection response operation may include the information informed by the information unit.

The electric device according to a fifth aspect of the present invention may further include: a message obtainer obtaining a message from an external apparatus through the access point; and a storage unit storing the message, wherein the person detection response operation may include an announcement of the message stored in the storage unit.

The electric device according to a sixth aspect of the present invention may further include an audio input unit configured to input audio, wherein the person detection response operation may include an input from the audio input unit.

The electric device according to a seventh aspect of the present invention may further include an audio input unit inputting audio, wherein the person detection response operation may include the input from the audio input unit, and the controller may enable an input from the audio input unit after the announcement of the message finishes.

The electric device according to an eighth aspect of the present invention may further include: a housing chamber; and a door opening and closing the housing chamber, wherein the person detector may include a door-close sensor detecting that the door is closed, and the controller may enable the input from the audio input unit if the door is closed.

In the electric device according to a ninth aspect of the present invention, the person detector may include a door-open sensor detecting that the door is open, and the controller may perform the person detection response operation if the door-open sensor detects that the door is open.

The electric device according to a tenth aspect of the present invention may further include: a stopper stopping the person detection response operation, wherein the controller may stop the person detection response operation when the stopper is operated.

A refrigerator according to an eleventh aspect of the present invention includes: a communications unit communicating with an external apparatus; a person detector detecting presence of a person in front of the refrigerator, and a person detection response operation unit causing the person detector to operate when the communications unit is in a connection state capable of communicating with the external apparatus, and transmitting and receiving information between the refrigerator and the external apparatus when the operation of the person detector detects presence of the person.

In the refrigerator according to a twelfth aspect of the present invention, the person detection response operation unit may include a voice output unit outputting a message transmitted from the external apparatus and received by the communications unit.

In the refrigerator according to a thirteenth aspect of the present invention, the person detection response operation unit may include a voice output unit and a voice obtainment unit, wherein person detection response operation unit may cause: the communications unit to transmit, to the external apparatus, voice data obtained by the voice obtainment unit; and the voice output unit to output a reply message in response to the voice data, the reply message being sent from the external apparatus and received by the communications unit.

In the refrigerator according to a fourteenth aspect of the present invention, the person detection response operation unit may determine that the person in presence is detected if the person detector detects the person for a predetermined time or longer.

In the refrigerator according to a fifteenth aspect of the present invention, the person detection response operation unit may include a voice output unit and a voice obtainment unit, wherein, if the external apparatus holds no message to be transmitted to the refrigerator, the person detection response operation unit may: cause the communications unit to transmit, to the external apparatus, the voice data obtained by the voice obtainment unit; and the voice output unit to output a reply message in response to the voice data, the reply message being sent from the external apparatus and received by the communications unit.

The refrigerator according to a sixteenth aspect of the present invention may further include: an indicator, and an indicator controller, wherein the message held in the external apparatus may include a plurality of messages each of which is different in kind, the person detection response operation unit may inquire of the external apparatus as to the kinds of the messages held in the external apparatus, and the indicator controller may cause the indicator to present a different indication depending on the kinds of the messages held in the external apparatus.

The refrigerator according to a seventeenth aspect of the present invention may further include: an indicator, and an indicator controller, wherein, when the voice obtainment unit is in an operation state, the indicator controller may cause the indicator to indicate the operation state.

The refrigerator according to an eighteenth aspect of the present invention may further include a stopper, wherein the person detection response operation unit may stop an operation of the voice output unit when the stopper is in operation.

The refrigerator according to the above aspects of the present invention may be implemented in the form of a computer. In this case, the computer may run as the units (software) included in the refrigerator, such that a control program of the refrigerator to be implemented in the computer, and a computer-readable recording medium in which the control program is recorded are included in the scope of the present invention.

The present invention shall not be limited to the embodiments described above, and can be modified in various manners within the scope of claims. The technical aspects disclosed in different embodiments are to be appropriately combined together to implement an embodiment. Such an embodiment shall be included within the technical scope of the present invention. Moreover, the technical aspects disclosed in each embodiment are combined to achieve a new technical feature.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An electric device comprising:
a communications unit configured to communicate with an access point;
a person detector configured to detect presence of a person; and
a controller configured to enable a person detection response operation to be performed based on detection of the presence of the person by the person detector if the communications unit is connected to the access point.

2. The electric device according to claim 1, wherein
the person detector includes a motion sensor configured to detect the presence of the person, and
the controller performs the person detection response operation if the motion sensor detects the presence of the person for a predetermined time period or longer.

3. The electric device according to claim 1, wherein
the person detector includes an operation detector configured to detect an operation of a user on the electric device, and
the controller performs the person detection response operation if the operation detector detects the operation of the user on the electric device.

4. The electric device according to claim 1 further comprising
an information unit configured to inform information, wherein
the person detection response operation includes the information informed by the information unit.

5. The electric device according to claim 4 further comprising
a message obtainer configured to obtain a message from an external apparatus through the access point; and
a storage unit configured to store the message, wherein
the person detection response operation includes an announcement of the message stored in the storage unit.

6. The electric device according to claim 1 further comprising
an audio input unit configured to input audio, wherein
the person detection response operation includes an input from the audio input unit.

7. The electric device according to claim 5 further comprising
an audio input unit configured to input audio, wherein
the person detection response operation includes an input from the audio input unit, and
the controller enables the input from the audio input unit after the announcement of the message finishes.

8. The electric device according to claim 6 further comprising
a housing chamber; and
a door configured to open and close the housing chamber, wherein
the person detector includes a door-close sensor configured to detect that the door is closed, and
the controller enables the input from the audio input unit if the door is closed.

9. The electric device according to claim 1, wherein
the person detector includes a door-open sensor configured to detect that the door is open, and
the controller performs the person detection response operation if the door-open sensor detects that the door is open.

10. The electric device according to claim 1 further comprising
a stopper configured to stop the person detection response operation, wherein
the controller stops the person detection response operation when the stopper is operated.
